(19) United States
(12) Patent Application Publication
(10) Pub. No.: US 2002/0070847 A1
(43) Pub. Date: Jun. 13, 2002

(54) Alarm for locking mechanism, and cabinet using same

(76) Inventors: Eugene R. Hamilton, Walker, MI (US); John T. Matthai, Middleville, MI (US); John G. Otto, Grandville, MI (US); Kevin O. Osborn, Mattawan, MI (US); Noel Carrillo, Grandville, MI (US); James M. Timmons, Caledonia, MI (US)

Correspondence Address: BRINKS HOFER GILSON & LIONE, P.O. BOX 10395, CHICAGO, IL, 60610, US

(21) Appl. No.: 09/733,633

(22) Filed: Dec. 7, 2000

(51) Int. Cl. G08B 1/00

(52) U.S. Cl. 340/309.15

(57) ABSTRACT

An alarm for indicating a locking barrier has been left open for a specified period of time, and a method for its use. An alarm circuit includes a timer, an alarm and a timer resetter. The timer begins a countdown when the locking barrier is left in an open position. If the countdown ends without the timer having been reset by the timer resetter, the alarm emits a signal indicating the locking barrier has been left in an unlocked position.

### BACKGROUND

The present invention relates generally to an alarm for use with a locking mechanism. More particularly, the present invention relates to an alarm for use with a locking mechanism on a cabinet, such as a cabinet adapted to contain pharmaceuticals and supplies.

Lockable pharmaceutical cabinets and carts are widely used in hospitals and other medical care facilities. Keeping pharmaceutical products secure from unauthorized access is a matter of major concern in medical care facilities, not only to protect against theft and misuse of the pharmaceuticals but also to comply with legal requirements concerning controlled substances. Security of pharmaceutical carts used for delivering and dispensing pharmaceutical substances are of particular concern since the carts are of necessity used in areas where they are within easy reach of patients and other non-medical personnel. It is a general requirement in hospitals and the like that pharmaceutical carts be locked when not attended by an authorized person.

One important advance in such cabinets is the use of a locking bar. Such locking bars are disclosed in U.S. Pat. Nos. 5,069,511, 5,205,628, and 5,314,244, all issued to Swets et al. These patents disclose a multiple drawer cabinet having a lockable vertically extending locking bar external to the cabinet and pivotally attached to one edge thereof. The locking bar, in its locked position, extends along the front of several drawers to obstruct their movement. This vertical locking bar cooperates with a plurality of horizontal locking bars to selectively allow and prevent removal of bins or drawers from a plurality of shelves of a cabinet.

The arrangement disclosed in these patents allows a plurality of bins or drawers to be locked in place by pivoting the locking bars into a locked position without the need for providing individual locks on the bins or requiring that the bins be contained within a lockable drawer or the like. Furthermore, the bins and drawers may be readily removed by unlocking the vertical locking bar, which will allow for free rotation of the horizontal locking bars, thereby providing for convenient removal of the bins individually.

Although providing a substantial improvement in the art, the cabinets disclosed in those patents did not provide for any system to alert medical personnel that the cabinet had not been locked. Thus, while the prior art cabinets provide for enhanced security in the storage of pharmaceuticals and supplies, this security was not realized unless personnel remembered to promptly close and lock the cabinet.

### SUMMARY

In one aspect of the invention, an alarm system for use with a locking mechanism includes an alarm, a timer, and a timer resetter. The timer is adapted to activate the alarm after a countdown period of time unless the countdown period is reset. The timer resetter is adapted to reset the timer. The timer resetter has a first position and a timer resetting position and is transitionable between the first position and the timer resetting position based upon movement one or more components of the locking mechanism.

In another aspect of the invention, a locking barrier includes a barrier housing, one or more locking members within the housing, and an alarm. The locking member(s) is moveable between a locked position and an unlocked position. The alarm is adapted to emit a signal when the locking member is not in its locked position for a countdown period of time.

In yet another aspect of the invention, a cabinet includes a cabinet housing, a locking barrier connected with the cabinet housing, and an alarm. The locking barrier is moveable between a closed position and open positions. The locking barrier is adapted to secure bins within the cabinet housing in their closed position when the locking barrier is in its closed position, and allows the bins to move to their open positions independently of the locking barrier when the locking barrier is in one of its open positions. The alarm is adapted to emit a signal when the locking barrier is not in its locked position for a countdown period of time.

In yet another aspect of the invention, a method is provided for activating an alarm when a locking mechanism of a cabinet has been left in an open position for a period of time. The method includes starting a countdown of a timer in response to movement of one or more component(s) of the locking mechanism. Then, an alarm is activated at the end of the countdown unless the timer is reset. The timer is adapted to be reset by a timer resetter, wherein the timer resetter is transitionable between an open position and a timer resetting position based upon movement of the one or more components of the locking mechanism.

Other aspects of the invention will be apparent to those skilled in the art in view of the following detailed description of the preferred embodiments, along with the accompanying drawings.

### BRIEF DESCRIPTION OF THE DRAWINGS

FIG. 1 is a perspective view of a cabinet utilizing a locking barrier with an alarm according to one embodiment of the present invention.

FIG. 2 is an exploded perspective view of the locking barrier and alarm according to one embodiment of the invention.

FIG. 3 is an exploded perspective view of an alarm associated with the bottom portion of the locking barrier of FIG. 2.

FIG. 4 is a rear view of the locking barrier and alarm with its back panel removed and the locking mechanism in the unlocked position.

FIG. 5 is a rear view of the locking barrier and alarm shown with its back panel removed and the locking mechanism in the locked position.

FIG. 6 is a flow diagram illustrating the operation of the alarm according to one embodiment of the invention.

FIG. 7 is a schematic diagram of an exemplary alarm circuit according to one embodiment of the invention.

### DETAILED DESCRIPTION OF THE PREFERRED EMBODIMENTS

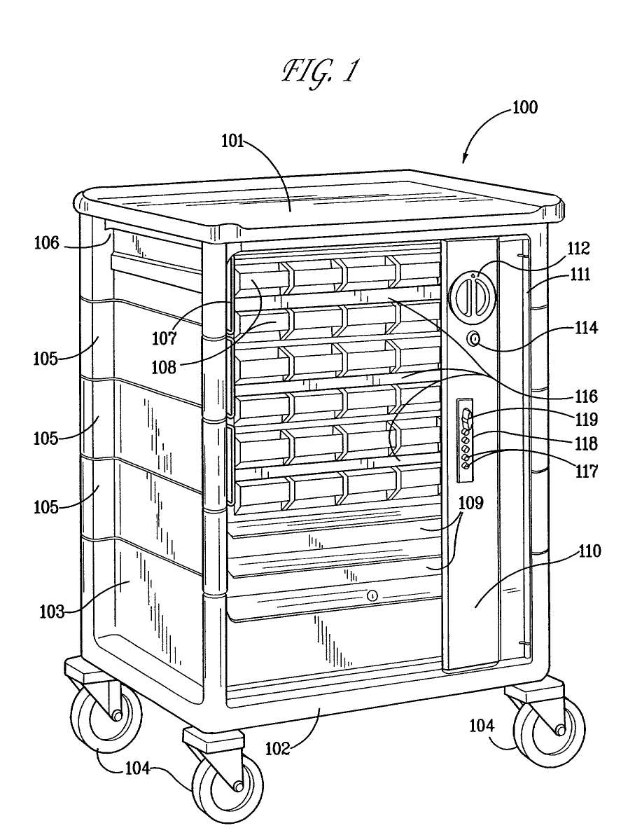

Referring now to the accompanying drawings and initially to FIG. 1, a cabinet according to a preferred embodiment of the invention is shown generally at 100. The cabinet 100 of the preferred embodiment is similar to the cabinets disclosed in U.S. Pat. Nos. 5,069,511, 5,205,628, and 5,314,244, and U.S. application Ser. No. ______, entitled “Locking Mechanism, And Locking Barrier and Cabinet Using Same,” filed Dec. 7, 2000 (Attorney Docket No. 4634/129) all of which are incorporated herein by reference in their entireties.

Briefly, the cabinet 100 is a segmented side wall pharmaceutical cabinet 100 having a housing including a top surface 101 and a base 102. The cabinet is provided with casters 104 and may be used as a pharmaceutical dispensing cart. The cabinet housing further includes a base side wall segment 103, middle side wall segments 105 and a top segment 106. It is provided with a plurality of drawers 109 for containing various items and a plurality of pharmaceutical cassettes 107, each containing a plurality of bins 108. Each of the cassettes 107 includes two rows of bins 108 disposed in a side-by-side relation, and is slidably removable from cabinet 100. Each of the cassettes 107 is further provided with a horizontally extending bin locking barrier 116 extending frontally along a lower portion of an upper row of bins and an upper portion of a lower row of bins. The bin locking barriers 116 have an elongated cross section and are rotatable between a horizontal releasing position allowing for removal of individual ones of the bins 108 and a vertical locking position in which removal of the bins 108 is restrained.

A vertically extending cabinet locking barrier 110 is hingedly attached to one side of cabinet 100 by means of hinge 111 and is rotatable between a locked position as shown in FIG. 1 and an unlocked position (not shown). In the embodiment shown, the locking barrier 110 is formed as a lock bar, but those skilled in the art will appreciate that in other embodiments the locking barrier 110 could be formed as a door, shield, or other barrier having a locking mechanism. When in the locked position, as shown in FIG. 1, cabinet locking barrier 110 cooperates with the horizontally extending bin locking barriers 116 of the individual cassettes 107, to lock each of the individual bins 108 in the cart. The details of the structure and operation of the cassettes 107, bins 108, and horizontally extending bin locking barriers 116 are described in detail in the above referenced patents.

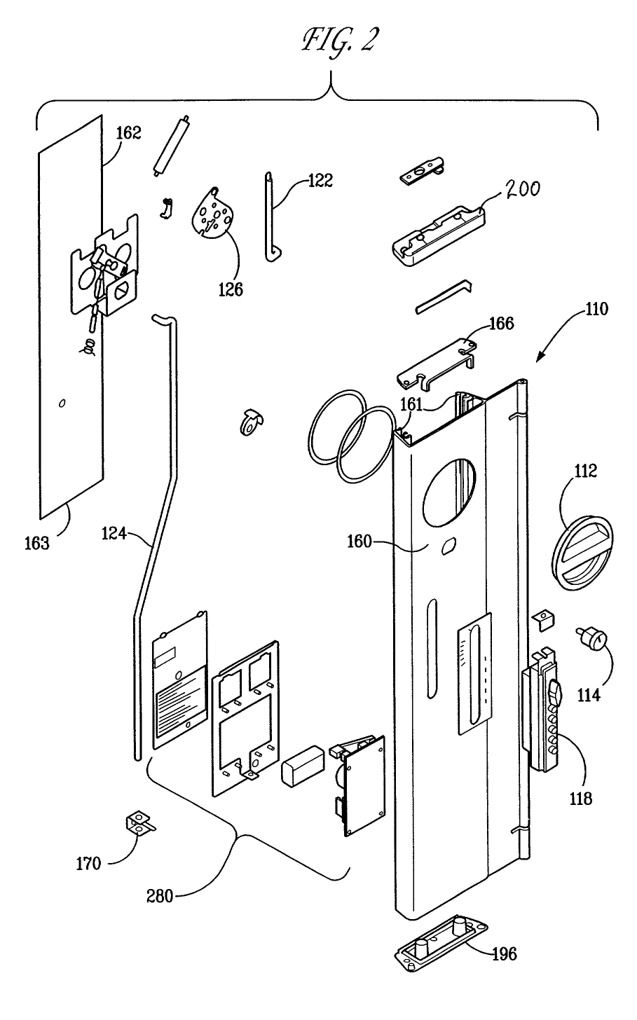

FIG. 2 illustrates the locking barrier 110 having an alarm 280 according to one embodiment of the invention. A locking mechanism is disposed within the locking barrier housing defined by front panel 160, a spaced rear panel 162, a bottom cap 196, and a top bracket 166 and a detent housing 200. The locking mechanism includes locking members defined by an upper locking pin 122 and a lower locking pin 124. Locking pins 122 and 124 are oriented so as to move in substantially parallel but opposite directions. An actuating disk 126 moves the locking pins 122 and 124. Locking pins 122 and 124, when in an extended position engage cavities (not shown) in the cabinet 100 and thereby secure the locking barrier 110 in a closed position. When locking pins 122 and 124 are in the retracted position, the locking barrier 110 is rotatable along hinge 111 to any of its open positions. The details of the operation of the locking mechanism is disclosed in co-pending U.S. application Ser. No. ______, entitled “Locking Mechanism, And Locking Barrier and Cabinet Using Same,” filed Dec. 7, 2000 (Attorney Docket No. 4634/129).

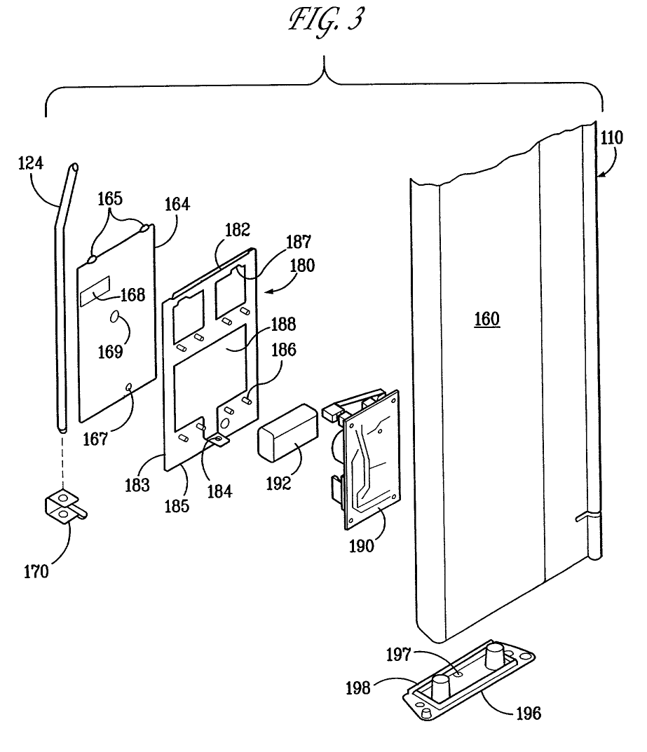

FIG. 3 illustrates the bottom portion of the locking barrier 110 which houses alarm 280. A printed circuit board 190 supports the components of the alarm circuit, as described in more detail below. A support plate 180 includes pins 186 that hold the support plate in place on the locking barrier 110. The edges 183 of the support plate 180 are secured by the channel 161 (FIG. 2) of the body of the locking barrier 110, and the support plate 180 is secured to the bottom cap 196 by a fastener (not shown) extending between aperture 184 and aperture 197, respectively. The bottom edge 185 of the support plate 180 engages and rests in channel 198 of the bottom cap 196. The support plate 110 is sized such that a lower edge 163 (FIG. 2) of the rear panel 162 engages and rests in a channel 182 when the locking barrier is assembled.

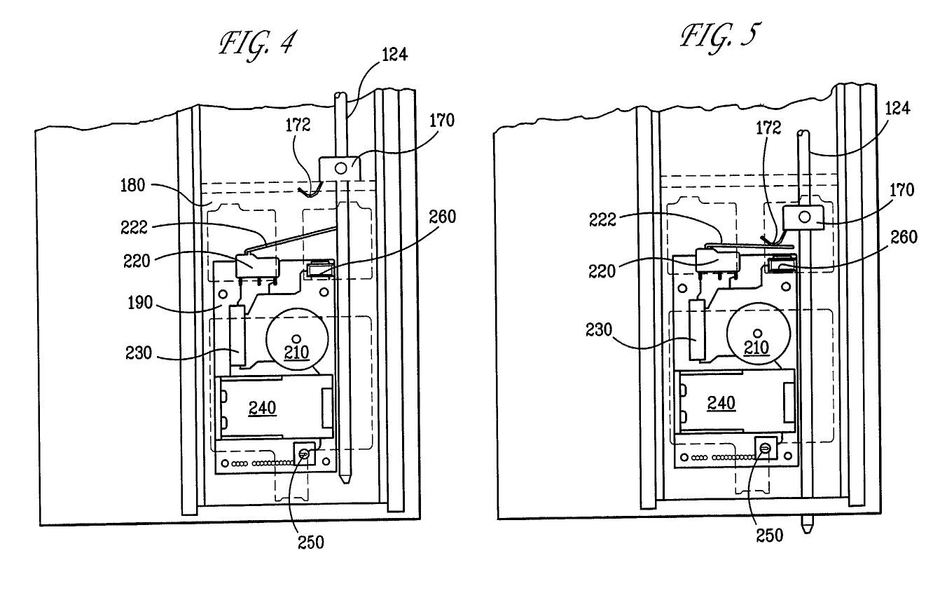

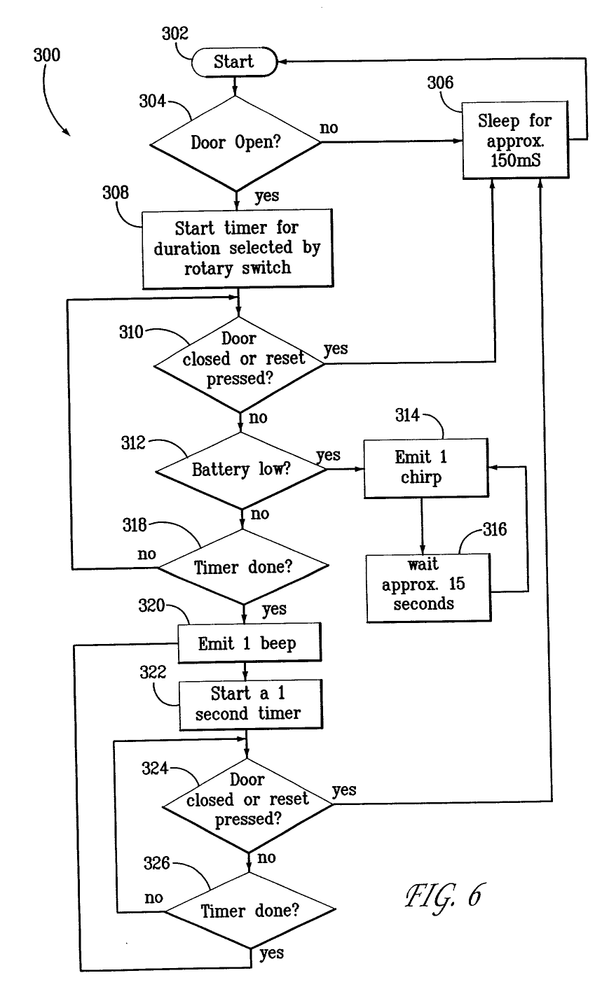

A battery cover 164 is adapted to be placed over the support plate 180. The battery cover 164 includes tabs 165 for engaging indents 187, and is secured to the support plate 180 by a fastener (not shown) through aperture 167. The battery cover 164 includes an aperture 168 for allowing a user to press a reset button 260 (FIGS. 4 and 5) without first removing the battery cover 164. The battery cover also includes an aperture 169 so that a sound can be heard emanating from speaker 210 (FIGS. 4 and 5). When the battery cover 164 is removed, a battery 192 can be replaced through aperture 188 of the support plate 180 and into a battery holder 240 (FIGS. 4 and 5).

FIGS. 4 and 5 illustrate the printed circuit board 190 secured within the locking barrier 110 (the support plate 180 is shown in phantom). The printed circuit board 190 carries an alarm circuit defined generally by an alarm speaker or buzzer 210, a battery holder 240, an integrated circuit 230, a timer resetter 220, an alarm inactivator 260, and a time period selector 250. Further details of the alarm circuit are described below and with reference to FIGS. 6 & 7.

The alarm circuit operates to activate the alarm speaker 210 if the locking barrier is left in an unlocked position for a period of time. The integrated circuit 230 is programmed to begin a countdown period when the timer resetter 220 in a first position. In the embodiment shown in FIG. 4, the timer resetter 220 is a switch having a lever 222 and is shown in an open circuit position as the first position. If the countdown period expires without the timer resetter 220 being moved to its timer resetting position, the alarm speaker will be activated. In FIG. 5, the timer resetting position is shown as the closed circuit position of the switch.

The timer resetter 220 is transitionable from its first position to a timer resetting position based upon movement of one or more components of the locking mechanism. In the embodiment shown, the timer resetter 220 is transitionable based upon movement of the locking pin 124. The locking pin 124 includes a timer resetter engaging member 170 having an extension 172. When the locking barrier is unlocked, the locking pin 124 is moved upward relative to the locking barrier 110, as on shown in FIG. 4. In this unlocked position, the extension 172 does not contact the lever 222. When the locking barrier 110 is locked, the extension 172 moves the lever 222 of the timer resetter 220 to its timer resetter position, as shown in FIG. 5. Those skilled in the art will appreciate that the timer resetter 220 and the locking mechanism may, in alternate embodiments, be configured so that the timed resetter 220 is transitionable based upon movement of other components of the locking mechanism, such as actuator 126.

The time period selector 250, shown in FIGS. 4 and 5 as a rotary switch, allows the user to select the length of the countdown period of time. Furthermore, the alarm inactivator 260 allows the user to manually reset the countdown period after the alarm speaker 210 is activated. In alternate embodiments, the alarm inactivator may be used to inactivate the alarm circuit indefinitely.

Referring now to FIG. 6, the flow chart 300 illustrates an algorithm for the alarm circuit shown in FIGS. 4-5 and 7. The process begins at 302. The circuit detects, at 304, whether the locking barrier 110 is open by determining the position of the timer resetter 220, as described above. If the locking barrier 110 is locked and the timer resetter 220 is in its timer resetting position, the circuit goes into a sleep mode, at 306, for a fixed period, for example, for about 150 microseconds. Then the determination at 304 is repeated.

If the locking barrier 110 is unlocked, and consequently the timer resetter 220 is not in its timing resetting position, the countdown period, previously selected by the time period selector 250, is begun at 308. If during the countdown, the locking barrier 110 is locked, or the timer inactivator is pressed, at 310, the alarm circuit goes into sleep mode at 306, and the entire process is repeated. In the preferred embodiment, the alarm circuit also includes a battery testing sub-circuit, and if the battery voltage is detected, at 312, to be low during the countdown period, the alarm speaker 210 emits a single short chirp at 314. The battery testing sub-circuit then rests, at 316, for another period, for example, 15 seconds, and then emits another chirp. The alarm circuit continues tracking the position of the timer resetter 220 until the countdown is complete at 318. If the countdown period expires without the timer resetter 220 having been set to its timer resetting position, the alarm speaker 210 emits a beep at 320. The alarm circuit starts a delay sub-countdown for one second at 322, and then determines whether the locking barrier 110 has been closed at 324. If the locking barrier 110 has been locked or the alarm inactivator 260 has been pressed, the alarm circuit goes into a sleep mode at 306, and the process is repeated. If, at 326, the locking barrier 110 has been not been locked and the alarm inactivator 260 has not been pressed, at the end of the delay sub-countdown, a beep is emitted by the alarm speaker 210 and the delay sub-countdown is repeated. Thus, the circuit will cause the alarm speaker 210 to continue emitting consecutive beeps until the locking barrier 110 is locked or the alarm inactivator 260 has been engaged.

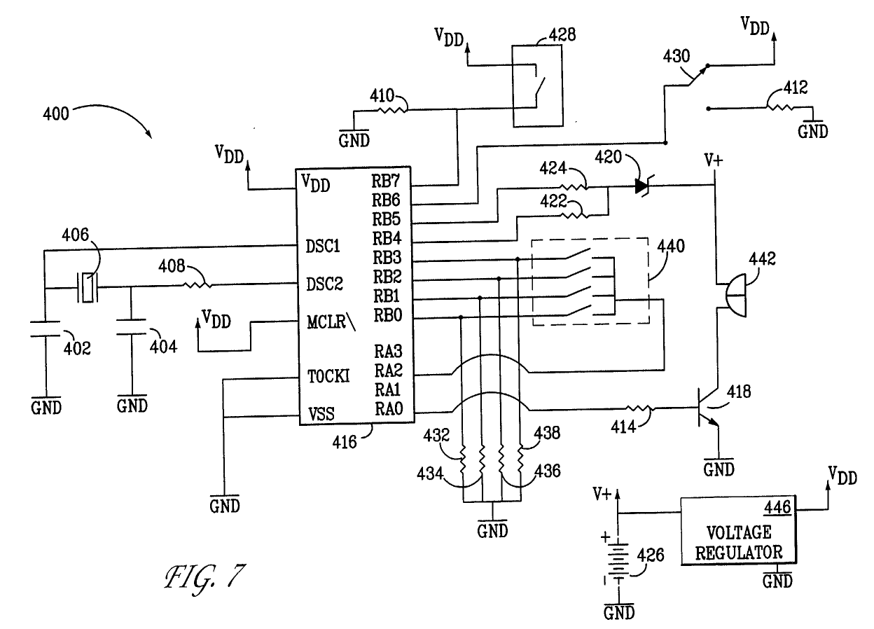

FIG. 7 illustrates an exemplary timing circuit 400 according to a presently preferred embodiment. The timing circuit 400 includes capacitors 402, 404, a crystal oscillator 406, resistors 408, 410, 412, 414, 422, 424, 432, 434, 436, 438, a transistor 418, a buzzer or alarm 442, a battery 426, a voltage regulator 446, a zener diode 420, a first rotary switch 428, a second rotary switch 440, a reset switch 430, and a controller 416. The crystal oscillator 406 provides a timing signal for the controller 416. In a presently preferred embodiment, the oscillator 406 is at a frequency of 6 MHz, although other timing signal frequencies may be utilized. In a preferred embodiment, the controller 416 is the chip 16C54P, although any suitable controller may be used.

Preferably, the transistor 418 is an npn bipolar junction transistor (BJT). The emitter of the BJT 418 is coupled to ground potential, the collector of the BJT 418 is coupled to the alarm 442, and the base of the BJT 418 is coupled to the base resistor 414. When the BJT is on, the collector current will cause the alarm 442 to sound. Varying the current through the BJT 418 will affect the nature of the sounds emitted by the alarm 442.

In a presently preferred embodiment, the voltage V+ of the battery 426 is approximately 9 volts, while a supply voltage VDD is approximately 3 volts. The voltage regulator 446 converts the battery voltage V+ for the battery 426 down to the supply voltage V_{DD}. The zener diode 420 and the resistors 422, 424 are used for low battery detection by the controller 416. When the battery voltage V+ drops below a certain voltage, for example 7.5 volts, the controller reads the voltage from the zener diode 420 at pins RB3 and RB4 and the controller provides a signal, preferably a pulse or a series of pulses, to the base input of the BJT 418 from pin RA0. The pulse or the series of pulses turns on the BJT 418 and causes the alarm 442 to emit a brief chirp or beep, thus providing an indication of low battery voltage.

The timer is reset by the reset switch 430, which switches the node at pin RB6 between the supply voltage VDD and ground potential through the resistor 412. This resets the timer at the controller 416. When the door to the medical cart opens or closes, the first rotary switch 428 is actuated and switches the pin RB7 between the supply voltage VDD and ground potential. This alerts the controller that the door is ajar or has been closed.

The pin RA2 is a common connection to the resistive path rotary switch 440. The setting of the resistive path rotary switch 440 determines the resistive path presented to the controller 416. The controller 416 infers from the resistive path which of the switches of the resistive path rotary switch are closed and which are open. The controller 416 is preferably programmed to vary the frequency of the tones of the alarm 442 and responsively supplies a current to the BJT 418 to affect the desired tone frequency for the alarm 442 as dictated by the setting of the rotary switch 440. While the rotary switch 440, and thus the resistive path, is preferably set to one combination for regular use, the setting of the rotary switch 440 may be modified to change the resistive path and thus generate a different tone sequence or frequency for the alarm 442.

It should be readily understood by those persons skilled in the art that the present invention is susceptible of a broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention.

For example, while the alarm has been disclosed as having an audible speaker, in an alternate embodiment, the alarm may have a visual signal. Accordingly, while the present invention has been described herein in detail in relation to a specific embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

1. An alarm system for use with a locking mechanism, comprising:
an alarm;
a timer adapted to activate said alarm after a countdown period of time unless the countdown period is reset; and
a timer resetter adapted to reset said timer; said timer resetter having a first position and a timer resetting position; said timer resetter transitionable between said first position and said timer resetting position based upon movement of at least one component of the locking mechanism.

2. The alarm system of claim 1, wherein the at least one component of the locking mechanism includes at least one locking member, and said timer resetter is transitionable based upon movement of the at least one locking member.

3. The alarm system of claim 2, wherein said at least one locking member comprises a locking pin.

4. The alarm system of claim 1, wherein the locking mechanism includes a timer resetter engaging member associated with said at least one locking member, said timer resetter engaging member adapted to engage said timer resetter and transition said timer resetter from said first position to said circuit resetting position.

5. The alarm system of claim 3, wherein said timer resetter is in said first position when said timer resetter engaging member is not engaging said timer resetter.

6. The alarm system of claim 1, wherein said alarm comprises an audio signal.

7. The alarm system of claim 1, further comprising a time period selector operable to allow selection of the length of the countdown period.

8. The alarm system of claim 1, further comprising an alarm inactivator adapted to reset the countdown period of said timer.

9. The alarm system of claim 1, wherein said alarm inactivator is operable to stop an activated alarm.

10. The alarm system of claim 9, wherein said alarm inactivator comprises a reset switch.

11. The alarm system of claim 1, wherein said timer resetter comprises a switch.

12. The alarm of claim 11, wherein said switch is in an open circuit position when in said first position, and in a closed circuit position when in said timer resetting position.

13. A locking barrier which emits a signal when left in an open position for a period of time, comprising:
a barrier housing;
at least one locking member within said housing, said at least one locking member moveable between a locked position and an unlocked position; and
an alarm adapted to emit a signal when said locking member is not in its locked position for a countdown period of time.

14. The locking barrier of claim 13, further comprising a first actuator rotationally mounted within said barrier housing, said actuator capable of rotation between a locked position and an unlocked position and biased towards the locked position, said actuator adapted to move said at least one locking member to its locked position.

15. The locking barrier of claim 13, further comprising a timer adapted to activate said alarm after said countdown period unless said timer is reset.

16. The locking barrier of claim 15, further comprising a timer resetter adapted to reset said timer, said timer resetter having a first position and a timer resetting position, said timer resetter transitionable between said first position and said timer resetting position based upon movement of said locking member.

17. A locking barrier comprising:
a barrier housing;
at least one locking member within said housing, and
an alarm circuit including an alarm, a timer and a switch, said timer operable to activate said alarm at the end of a countdown period, said switch operable to reset said countdown period, said switch moveable between a first position and a timer resetting position in response to movement of said locking member.

18. The locking barrier of claim 17, further comprising a first actuator rotationally mounted within said housing, said actuator capable of rotation between a locked position and an unlocked position and biased towards the locked position, said actuator adapted to move said at least one locking member to its locked position.

19. The locking barrier of claim 17, further comprising a switch engaging member positioned to contact said switch in response to movement of said locking member.

20. The locking barrier of claim 19, wherein said switch engaging member is associated with said locking member.

21. The locking barrier of claim 20, wherein said at least one locking member is moveable between a locked position and an unlocked position, said switch engaging member adapted to reset said switch when said at least one locking member is in a locked position.

22. A cabinet comprising:
a cabinet housing;
a locking barrier connected with said cabinet housing and moveable between a closed position and open positions, said locking barrier adapted to secure bins within said cabinet housing in their closed position when said locking barrier is in its closed position, and allowing said bins to move to their open positions independently of said locking barrier when said locking barrier is in one of its open positions; and
an alarm adapted to emit a signal when said locking barrier is not in its locked position for a countdown period of time.

23. The cabinet of claim 22, further comprising a locking mechanism associated with said locking barrier, said locking mechanism including at least one locking member capable of locking said locking barrier in its closed position.

24. The cabinet of claim 22, wherein said cabinet housing contains a plurality of bins adapted to contain pharmaceutical supplies.

25. The cabinet of claim 22, wherein said locking barrier comprises a lock bar.

26. A method for activating an alarm when a locking mechanism of a cabinet has been left in an open position for a period of time, comprising:
starting a countdown of a timer in response to movement of at least one component of the locking mechanism;
activating an alarm at the end of the countdown unless the timer is reset;
wherein said timer is reset by a timer resetter, said timer resetter transitionable between an open position and a timer resetting position based upon movement of said at least one component of the locking mechanism.

27. The method of claim 26, wherein said countdown begins when the locking mechanism moves from a locked position to an unlocked position.

28. The method of claim 26, wherein said timer is reset when the locking mechanism moves from an unlocked position to a locked position.

29. The method of claim 26, wherein said at least one component comprises at least locking member.
